(19) United States
(12) Patent Application Publication
(10) Pub. No.: US 2014/0172701 A1
(43) Pub. Date: Jun. 19, 2014

(54) Funds Transfer Using Two Dimensional Barcodes

(71) Applicant: iGate Technologies Inc., Fremont, CA (US)

(72) Inventor: Rahul Pandhare, Pune (IN)

(73) Assignee: iGate Technologies Inc., Fremont, CA (US)

(21) Appl. No.: 14/132,463

(22) Filed: Dec. 18, 2013

Related U.S. Application Data
(60) Provisional application No. 61/738,471, filed on Dec. 18, 2012.

(51) Int. Cl. G06Q 20/32; G06Q 20/10

(52) U.S. Cl. CPC G06Q 20/322; G06Q 20/108
USPC 705/41

(57) ABSTRACT

A system and method for initiating financial transactions utilize the display of a two-dimensional barcode on a mobile electronic device. A payor enters a sequence number pertaining to a prepaid transaction into a payor device and securely transmits these data to a payor bank. The bank generates a password-protected two-dimensional barcode using the sequence number. The barcode may be a QR code. The barcode and password are separately sent to a payee device, either directly from the bank or through the payor device using wireless communications such as MMS or NFC. Once the password is entered, the payee device displays the barcode on a screen so it may be scanned by a payee bank scanner or ATM scanner or submitted to a payee's financial services organization system. Scanning or submitting the barcode initiates the financial transaction.

### CROSS REFERENCE TO RELATED APPLICATION

This application claims the benefit of U.S. Provisional Application 61/738,471 filed Dec. 18, 2012, the contents of which are herein incorporated by reference in their entirety.

### TECHNICAL FIELD

The present invention relates to systems controlled by data bearing records, and more particularly to systems and methods of banking and otherwise exchanging value between parties using images of two dimensional barcodes.

### BACKGROUND ART

There are several techniques known in the art for transferring money between a buyer and a seller without using cash. Cashless transactions are tied to a financial account that holds some value, either money or an ability to draw on credit. Purchases may be made using a debit card or a personal check that draws on funds that are available in the account. Purchases also may be made on credit using a credit card.

Cashless transactions are prone to fraud. For example, the information stored on the magnet stripe of a credit or debit card can be “skimmed”, and a duplicate card created that is used to fraudulently remove money from a financial account. Similarly, personal checks can be forged, if the information on the check can be duplicated on another piece of paper.

Because of the possibility of fraud, the guardian of the account—that is, a bank, money manager, or other financial services organization—typically requires authentication for an individual to access the financial account. Credit cards now come with “verification codes” printed directly on them, and such codes are required by merchants in transactions where a card is not present. Also, it is known in the art to authenticate checks and credit cards using two-dimensional barcodes. For example, U.S. Pub. 2009/0261158 by Lawson describes printing a two-dimensional barcode on a bank check to prove that the check was drafted by the account holder. Similarly, U.S. Pat. No. 8,002,175 by Kuriyama et al. teaches displaying a two-dimensional barcode image on a mobile phone to replace magnetic stripe information cards, including credit cards and debit cards. LevelUp is a mobile payment platform from SCVNGR of Cambridge, Mass. that includes mobile phone software that displays a QR code that is linked to a credit or debit card to facilitate transactions.

Prior art systems generate barcodes for authentication purposes by the payee, such as a merchant. Typically, a prior art transaction includes mutual identification by the merchant (payee) and customer (payor) of a product or service and a price. The merchant then generates a barcode that is tied to a merchant bank account and indicates details of the transaction, including price. The customer then uses a smartphone or other electronic device to scan the barcode, at which time they are required to confirm the transaction and provide payment information.

### SUMMARY OF THE INVENTION

Illustrative embodiments of the present invention supplement or replace existing physical checks and physical debit systems by encoding all of the relevant transactional information, including transactional sequence identifiers, in a two-dimensional barcode image that may be displayed on a payee mobile phone, at the initiation of the payor. Such embodiments produce sequential data not found in prior art credit card and debit card payment systems, thereby advantageously avoiding replay fraud, while avoiding the need to carry around a separate check book that can be lost or stolen.

In a first embodiment of the invention there is provided a computer system for initiating a financial transaction between a payor and a payee, the computer system having a memory for receiving, from a payor mobile electronic device, data pertaining to identification of the payee, a pre-issued virtual check number associated with a payor financial account, and a transaction amount; an image generator for generating an image of a two dimensional barcode that encodes the received data; and a communications port for transmitting the image toward a payee mobile electronic device for display of the image by the payee mobile electronic device to an image sensor of a payee financial services organization, wherein displaying of the image causes the payee financial services organization to initiate a transfer, of the transaction amount, from the payor financial account, to an account of the payee, according to the pre-issued virtual check number.

The system may have at least the following variations. One or both of the payee mobile electronic device and the payor mobile electronic device may be a smartphone. The two dimensional barcode may be a QR code. The image may be transmitted to the payee mobile electronic device from the payor mobile electronic device, and if so, it may be transmitted using any wireless communication mechanism between the devices, including without limitation Multimedia Messaging Service (MMS), email, chat, screen sharing, and near field communication (NFC). Alternatively, the image may be transmitted to the payee mobile electronic device from an electronic system of the payor financial services organization. The image sensor may be an ATM or a bank teller device. The barcode image may further encode a unique transaction sequence number.

In a second embodiment of the invention there is provided a method of initiating a financial transaction between a payor and a payee, the method comprising: receiving, in a payor mobile electronic device, data pertaining to identification of the payee and a transaction amount; selecting, by the payor mobile electronic device, a pre-issued virtual check number associated with a payor financial account for use in the financial transaction; generating an image of a two dimensional barcode that encodes the received data and the pre-issued virtual check number; and transmitting the image toward a payee mobile electronic device for display of the image by the payee mobile electronic device to an image sensor of a payee financial services organization, wherein displaying of the image causes the payee financial services organization to initiate a transfer, of the transaction amount, from the payor financial account, to an account of the payee, according to the pre-issued virtual check number. The method may be varied in accordance with the aforementioned system variations.

In a third embodiment of the invention there is provided a computer-readable medium in which is stored non-transitory computer program code for initiating a financial transaction between a payor and a payee, the computer program code comprising: program code for receiving, in a payor mobile electronic device, data pertaining to identification of the payee and a transaction amount; program code for selecting, by the payor mobile electronic device, a pre-issued virtual check number associated with a payor financial account for use in the financial transaction; program code for generating an image of a two dimensional barcode that encodes the received data and the pre-issued virtual check number; and program code for transmitting the image toward a payee mobile electronic device for display of the image by the payee mobile electronic device to an image sensor of a payee financial services organization, wherein displaying of the image causes the payee financial services organization to initiate a transfer, of the transaction amount, from the payor financial account, to an account of the payee, according to the pre-issued virtual check number. The aforementioned system and method variations may be applied to the program code on the medium.

### BRIEF DESCRIPTION OF THE DRAWINGS

The foregoing features of the invention will be more readily understood by reference to the following detailed description, taken with reference to the accompanying drawings, in which:

FIG. 1 is a schematic diagram of a system embodiment of the invention;

FIG. 2 is a flowchart showing a method of generating a two dimensional barcode in a payor server in accordance with an embodiment of the invention; and

FIG. 3 shows the technical architecture of a portion of the system shown in FIG. 1.

### DETAILED DESCRIPTION OF SPECIFIC EMBODIMENTS

Definitions. As used in this description and the accompanying claims, the following terms shall have the meanings indicated, unless the context otherwise requires:

A “mobile electronic device” is any portable electronic device capable of processing electrical signals in accordance with the techniques described herein, and may be without limitation a smartphone or a tablet computer.

A “financial services organization” is an organization that provides financial services such as depository banking, investing, wealth management, lending, and extension of credit.

A “transaction sequence number” is a number used by a financial services organization to uniquely identify a transaction.

A “pre-issued virtual check” is a data structure that represents at least the same data as a physical check, is associated with a payor financial account, and has a check number issued by a payor financial services institution prior to the initiation of a financial transaction in which it is used. The data structure may be encoded electronically, or may be represented by an image such as a two dimensional barcode.

A “two dimensional barcode” or “matrix code” is a representation of data that is designed for display as a two dimensional image. Two dimensional barcodes include Aztec Code, originally from Welch Allyn, Inc. of Skaneateles, N.Y. and described in International Standard ISO/IEC 24778; Data Matrix from Microscan Systems, Inc. of Renton, Wash. and described in ISO/IEC 16022; PDF417 originally from Symbol Technologies of Holtsville, N.Y. and described in ISO/IEC 15438; and QR Code, originally from Denso Wave of Kariya, Japan and described in ISO/IEC 18004, among many others known in the art.

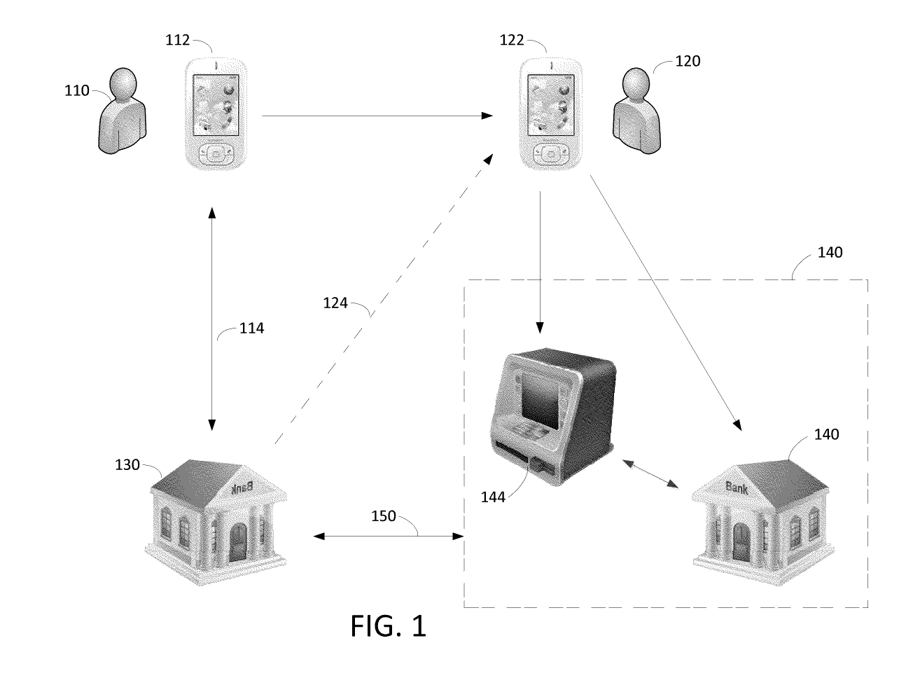

FIG. 1 is a schematic diagram of a system embodiment of the invention. The system facilitates financial transactions between a payor 110 and a payee 120 at the initiation of the payor 110 using pre-issued virtual check numbers. The system includes payor mobile electronic device 112 that is configured to receive from the payor 110 data pertaining to a transaction with the payee 120. The data may include, for example, a transaction amount, a transaction effective date, a payee name, and a payee mobile telephone number.

The payor mobile electronic device 112 may request to transfer funds using these data, in combination with a pre-issued virtual check number, described in more detail below. For example, the data may be received using a first displayed screen, and confirmed on a second displayed screen. Persons skilled in the art of user interfaces may develop equivalent methods of confirming a transaction using a display. The payor mobile electronic device 112 is configured to transmit the input data and a virtual check number to a server 130 of a payor financial services organization using a public data communications network 114 such as a cellular telephone data network, and to receive in return an image of a two dimensional barcode that incorporates all of these data, and optionally additional data provided by the financial services organization. Advantageously, according to this embodiment no barcode generating or reading software is required to be installed in the payor mobile electronic device 112. The two dimensional barcode acts as an electronic-only simulated bank check, virtually drafted by the payor 110, thereby eliminating the need for a physical paper check.

The system embodiment also includes a payee mobile electronic device 122. The payee mobile electronic device 122 is configured to receive the image of the two dimensional barcode from the payor mobile electronic device 112 or the server 130, and is correspondingly configured to receive and display the image. Transmission of the image from the payor mobile electronic device 112 may occur using any wireless communications method including the Multimedia Messaging Service (MMS), email, chat service, or if the devices 112, 122 are in close proximity, using Near Field Communications (NFC). In an alternate embodiment, the payor financial services organization 130 of the payor financial services organization may transmit the image directly to the payee mobile electronic device 122, using an appropriate data communications network 124 such as a cellular telephone data network. The payee mobile electronic device 122 also is configured to display details about the transaction associated with the received image. In particular, the payee mobile electronic device 122 may contact the payor financial services organization 130 using the network 124, to permit the payee 120 to review the transaction. The transfer of the barcode to the payee 120 at the request of the payor 110 is similar in effect to the transfer of a physical bank check from the payor 110 to the payee 120.

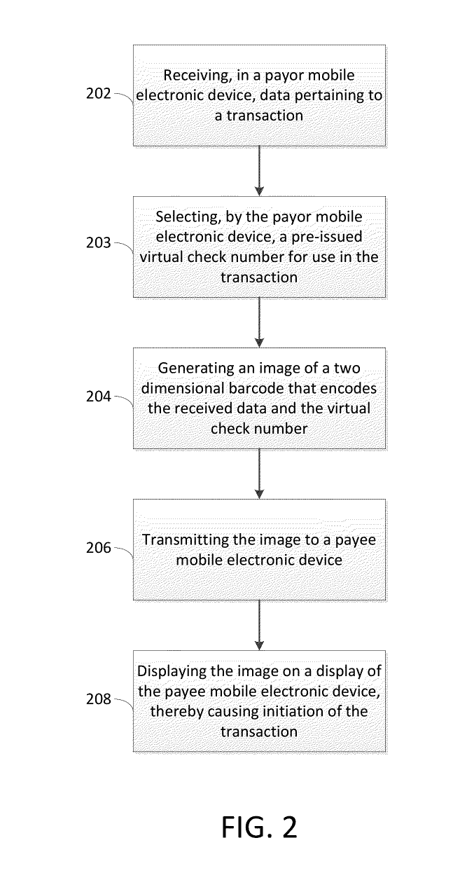

The payor mobile electronic device 112 and payee mobile electronic device 122 may be smartphones or tablet computers configured according to conventional data receiving, manipulating, displaying, and networking techniques known in the art. A detailed description of the configuration of the server of financial services organization 130 is given below in connection with FIG. 2.

The system embodiment further includes a payee financial services organization 140, which may have one or more branches 142 and one or more ATMs 144. The payee mobile electronic device 122 is configured to display the image of the two dimensional barcode so that it may be scanned by a scanner in a branch 142 or an ATM 144. Scanning the barcode is similar to the payee 120 attempting to deposit the virtual bank check. The scanner itself may be entirely conventional. Once the barcode has been scanned, the payee financial services organization 140 sends the data encoded by the barcode to the payor financial services organization 130 using a data communications network 150, such as an automated clearing house (ACH), to initiate a funds transfer, much as the information from a physical check would be used. For example, large domestic transactions may use the FedWire system provided by the United States Federal Reserve. Member organizations may use the Clearing House Interbank Payments System (CHIPS) for higher value but less time-sensitive transactions. Smaller transactions and transactions between other organizations may use the Electronic Payments Network (EPN) or a publicly-owned ACH. International transactions may use the Society for Worldwide Interbank Financial Telecommunication (SWIFT) network. The determination of which network 150 to use generally is made by the payee bank 140. Once initiated, the funds transfer proceeds as is known in the art of physical check funds transfers.

FIG. 2 is a flowchart showing a method of initiating a transaction using a payee mobile electronic device in accordance with an embodiment of the invention. It will be appreciated that, prior to the beginning of this process, the payor 110 will arrange to have her financial services institution issue a number of blank virtual checks that are tied to an account she has with the institution. Each such virtual check will have a number that is similar to a physical check number. These virtual checks are considered “pre-issued” because they are issued by the financial services institution prior to initiating a funds transfer. The server 130 transmits the pre-issued virtual check numbers to the payor's mobile electronic device 112 prior to the processes of FIG. 2.

In process 202, data pertaining to a transaction are received in a payor mobile electronic device 112 at the initiation of the payor. These data may include, for example, a transaction amount, a transaction date, a payee name, and a payee mobile telephone number. The transaction date may be used if the payor 110 does not wish for the transaction to complete until a later date, similar to post-dating a physical check. The payee name and mobile telephone number are used to identify and communicate with the payee.

In process 203, the payor's mobile electronic device 112 selects a virtual check number to use in this transaction. As explained above, the mobile electronic device 112 already has received a list of pre-issued virtual check numbers. The process 203 consists of selecting one of these; in a preferred embodiment, the smallest available number is chosen. If no virtual check numbers are useable, then the payor must stop the processes of FIG. 2 and arrange to have additional virtual checks issued. This situation is analogous to the payor exhausting her supply of physical checks and ordering a new check book.

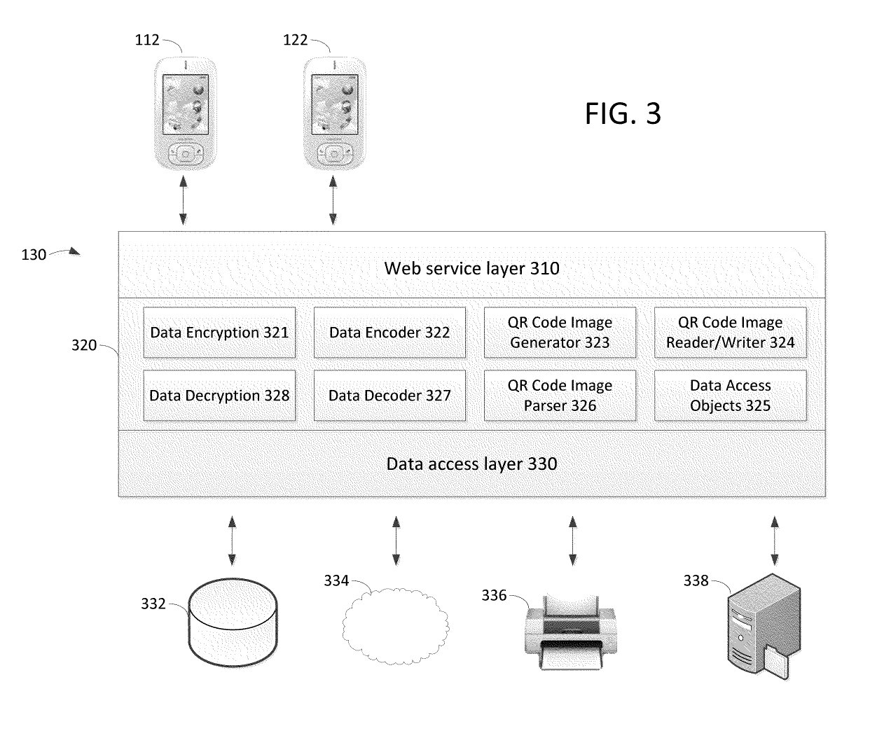

Next, the method requires generating an image of a two dimensional barcode that encodes the received data and the virtual check number in process 204. Generation of the image may be done using conventional means, such as the QR code image generator described below in connection with FIG. 3. In a preferred embodiment, the payor mobile electronic device 112 transmits the data and the virtual check number to a server 130 of a payor financial services institution, such as the payor's bank. The bank then encrypts the data and generates the image, providing a password for unlocking the image. However, in an alternate embodiment, the payor's mobile electronic device 112 may generate the image, provided it also communicates the transaction information to the server 130 to permit later authorization of the transaction.

In process 206, the (encrypted) image is transmitted to a payee mobile electronic device 122. In one embodiment, the protected image and the password are sent back to the payor's mobile electronic device 112 for verification, by the payor 110, of the transaction details before subsequent transmission by the payor 110 to the payee 120. The payor 110 may send the image to the payee 120 using any communication method known in the art, such as the Multimedia Messaging Service (MMS), email, chat, screen sharing, or near field communication (NFC). A preferred embodiment uses NFC to send the image, so that the image does not travel over a public network and the payor 110 can verify immediately that the image was properly received by the payee 120. The password may then be communicated to the payee 120, verbally or electronically, preferably using a different communication channel than was used to communicate the image.

In an alternate embodiment described in more detail below, in process 206 the payor's financial services organization 130 sends the image directly to the payee's mobile electronic device 122, for example using MMS. In this alternate embodiment, the payor's financial services organization 130 may send the password separately to the payee 120, for example to an email address previously confirmed to belong to the payee 120 (or his designee). The use of two different channels of communication for the image and the password prevents a man-in-the-middle from obtaining all of the data necessary to fraudulently “cash” the virtual bank check.

Finally, in process 208, the payee 120 displays the image on a display of the payee's mobile electronic device 122, causing initiation of the transaction. This process 208 typically occurs at a bank branch or an ATM having a scanner that scans the displayed barcode. The payee 120 must enter the image password at this time to confirm the funds transfer. If multiple two dimensional barcode images are present on the payee's mobile electronic device 122, the payee 120 may first select a transaction identifier or sequence number before entering the appropriate password. As an alternative to process 208, the payee 120 may submit the image electronically, rather than optically, to a system of the payee's financial services organization. For example, the payee 120 may transmit the image data to a computer system of the financial services organization using an available wireless communication system. As with optical display, the image data must be decrypted using the password before the funds transfer may begin.

Other processes may supplement this method. For example, the payor and payee mobile devices 112, 122 may require authentication before they may be used by the payor and payee 110, 120 respectively. Moreover, a software application may be provided on the mobile electronic devices to implement some of the above processes, and the application may be password-protected. Various encryption algorithms may be used between the mobile electronic devices and the respective financial services organizations. Other variations on the processes above may be used to increase the security of the system according to techniques known in the art. For example, the data encoded by the two dimensional barcode may be encrypted by the payor financial services organization 130 according to an encryption process that is decryptable only by that organization. Any appropriate encryption method known in the art may be used. The encrypted data may be encoded in the barcode directly, or simply stored by the payor financial services organization. In the latter case, only a reference to the data such as a bank sequence number or the virtual check number needs to be stored in the barcode.

FIG. 3 shows the technical architecture of an example server of the payor financial services organization 130 shown in FIG. 1 as implemented in a preferred embodiment. The server has a conventional three-tiered software architecture, including a presentation (web service) layer 310, a business logic layer 320, and a data access layer 330.

The purpose of the web service layer 310 is to service requests from client devices such as the mobile electronic devices 112, 122 and payee bank systems, and to respond with all of the information these devices need to display an application interface (i.e., a web page or the graphical user interface of an app). The web service layer 310 may be implemented using Jersey, a Java software package known in the art for web services conforming to representational state transfer (REST) as known in the art. The web services layer 310 isolates the different communication styles of the many different possible accessing client devices from the other computer logic; that is, it is the only layer that must be aware of how different client devices send and receive data, and it translates requests and responses to and from various client data formats.

The purpose of the business logic layer 320 is to receive requests from the presentation layer 310 and to apply business rules to provide a response. Such business rules may be encapsulated within Java objects, and are discussed in more detail below. Once a response is determined, the business logic layer 320 provides the presentation layer 310 with the information it requires to format an appropriate response. Because the business rules are isolated from the client-specific communications requirements, any changes to the business objects automatically become effective for all clients, and new client protocols may be added without disturbing the operation of the existing business rules.

The purpose of the data access layer 330 is to provide persistence and other services for the business logic layer 320. During normal operation, a business object in the business logic layer 320 typically loads state data from a persistent memory (such as a database 332), operates on it according to the request, responds to the request, and may store new state data to the persistent memory—the data access layer 330 provides the loading and storing functionality using a uniform interface. Moreover, if the business object requires access to a network connection 334, a printer 336, or a file server 338, the data access layer 330 provides access to these other instrumentalities. The data access layer 330 provides a uniform interface by which all business objects have access to these services, and isolates the creation, reading, updating, and deleting of persistent data from the logic that requires such functions. In this way, changes to business objects may be made without concern about the specific implementation details of the storage arrangement or other service, and additional services may be provided to all business objects without disturbing the operation of the existing business rules using a plug-in architecture. The data access layer 330 may use Hibernate, an object-relational mapping package known in the art for persisting Java software objects to a relational database 332, as well as other objects and methods for providing services to the business logic layer 320.

The business logic layer 320 includes a number of functional components that are required to implement core business logic. Components 321-325 are used in connection with process 204 as described above, while components 324-328 are used in connection with process 208 as described above. The particular functions of each of these components are now described in detail.

The data encryption component 321 provides security for the payor's financial data. The component receives funds transfer data from the payor mobile electronic device 112 via the web service layer 310, and encrypts the data using an encryption algorithm that has a password. The funds transfer data include data pertaining to at least a virtual check number, a transaction amount, and identification of the payee (for example, by name, telephone number, email address, or other identification). The encryption algorithm may be any algorithm in the art that can be initialized or seeded using the password or a known function of the password. The password itself may be provided by the payor or generated by the component 321. Information about the encryption algorithm and any encryption keys are stored in the data access layer 330 via data access objects 325. The outputs of the data encryption component 321 are a password and the payor's transactional data encrypted using the password.

The data encoder 322 encodes the encrypted data into a format that may be used in a two dimensional barcode. For purposes of discussion, the barcode discussed will be a QR code, although this discussion should not be seen to limit the scope of the claims. As is known in the art, QR code images include codewords that provide error correction. Such error correction is useful because the images are designed to be optically scanned using an image scanner in a high noise environment, and the encoded data must therefore have redundancy. The data encoder 322 takes the output of the data encryption component 321 and encodes it into QR codewords. The data encoder 322 also may add header information to the data to indicate a routing number of the payor's bank and/or the sequence number, to facilitate display of the QR code on the payee mobile electronic device. The data encoder 322 also may determine an appropriate masking pattern to apply to the codewords to ensure that there are no large blank areas in the image, and perform other routine tasks known in the art of QR codes. The output of the data encoder 322 is a text string of codewords to be converted into an image.

The QR code image generator 323 receives the text string of codewords and generates a QR code image from it. The process for doing so is known in the art, and not described in further detail here. QR code images come in several sizes, and the QR code image generator 323 determines the size of the image as a function of the length of the text string to be converted. The image itself may be in any common image format, such as GIF, JPEG, or PDF.

Next, the QR code image reader/writer 324 writes the QR code image to a file system, for example on file server 338, using a data access object 325. The server 130 maintains a collection of all QR code images that have been generated. These stored images may be used for any number of reasons, for example to retransmit a QR code on request of the payor or the payee, or to keep a record of pending and completed funds transfers. The QR code image reader/writer 324 also provides the QR code image to a mobile electronic device (via the web service layer 310) using a communications port. In one embodiment, this is the payor device 112, and the payor subsequently transmits this QR code image to the payee device 122 (for example, via MMS or NFC). In this embodiment, the password is sent directly to the payee mobile electronic device 122. In another embodiment, the reader/writer 324 provides the QR code image to the payee device 122 directly by wireless communication (for example, using a network 334 via the data access layer 330). In this embodiment, the password is not sent directly to the payee mobile electronic device 122, but is communicated to the payee via another communication channel (e.g., email). It should be clear in either case that the server transmits the QR code image for eventual delivery to the payee mobile electronic device 122.

Throughout the processes described above, the various business objects 321-324 may have other need to transmit or persist data. For example, each object may wish to record its operation in a log for debugging or auditing purposes. To transmit or persist these data, the objects 321-324 may use data access objects 325 that communicate directly with an interface provided by the data access layer 330. The use of separate data access objects 325 encapsulates the intricacies of the underlying storage and service mechanisms of the data access layer 330, thereby isolating them from the other business objects.

Referring to FIG. 2, the above processes are performed in connection with process 204 (and optionally process 206), after which the payee mobile electronic device has received the QR code image. Subsequently, in process 208, the payee displays the image on the display of the device for scanning at an ATM or bank branch, to initiate the actual funds transfer of the transaction amount from the payor bank to the payee bank. At this time, the payee may be required to enter the password generated by the data encryption component 321. The payee bank computer system determines the payor bank based on header information in the QR code image. If the payor and payee are using the same bank for the transaction, then the QR code image is processed by the bank server 130. If the payor and payee are using different banks, then the payee bank sends the image and the password to the payor bank. In either event, the remainder of the process described below is the same.

The funds transfer of process 208 is initiated as follows. Referring to FIG. 3, the steps used to produce the QR code image from financial data are reversed. Thus, the QR code image reader/writer 324 receives the QR code image from the payee's bank. The reader/writer 324 optionally may read the image from the file server 338 to compare the transmitted image to the received image to confirm its integrity. In any event, the reader/writer 324 passes the image to the QR code image parser 326, which converts the QR code image data into a text string of codewords—the opposite of the function of the QR code image generator 323. Next, the codewords are passed to the data decoder 327, which decodes them—the opposite of the function of the data encoder 322. Finally, the decoded data and the password are passed to the data decryption component 328, which decrypts the sensitive financial data—the opposite of the function of the data encryption component 321. If the password is incorrect, the decryption component 322 fails and provides an error message to the payee bank system. If the password is correct, the decryption component 328 decrypts the image data and, if the transaction date indicates that the transaction should proceed, a funds transfer to the payee bank begins.

The embodiments of the invention described above are intended to be merely exemplary; numerous variations and modifications will be apparent to those skilled in the art. All such variations and modifications are intended to be within the scope of the present invention as defined in any appended claims. JAVA is a registered trademark of Oracle Corporation of Redwood City, Calif. QR CODE is a registered trademark of Denso Wave, a subsidiary of Denso Corporation of Kariya City, Aichi Prefecture, Japan.

It should be noted that the logic flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

What is claimed is:

1. A computer system for initiating a financial transaction between a payor and a payee, the computer system comprising:
a memory for receiving, from a payor mobile electronic device, data pertaining to identification of the payee, a pre-issued virtual check number associated with a payor financial account, and a transaction amount;
an image generator for generating an image of a two dimensional barcode that encodes the received data; and
a communications port for transmitting the image toward a payee mobile electronic device for display of the image by the payee mobile electronic device to an image sensor of a payee financial services organization, wherein displaying of the image causes the payee financial services organization to initiate a transfer, of the transaction amount, from the payor financial account, to an account of the payee, according to the pre-issued virtual check number.

2. A system according to claim 1, wherein one or both of the payee mobile electronic device and the payor mobile electronic device is a smartphone.

3. A system according to claim 1, wherein the two dimensional barcode is a QR code.

4. A system according to claim 1, wherein the image is transmitted to the payee mobile electronic device from the payor mobile electronic device.

5. A system according to claim 4, wherein the image is transmitted using MMS, email, chat, screen sharing, or NFC.

6. A system according to claim 1, wherein the image is transmitted to the payee mobile electronic device from an electronic system of the payor financial services organization.

7. A system according to claim 1, wherein the image sensor comprises an ATM or a bank teller device.

8. A system according to claim 1, wherein the barcode image further encodes a unique transaction sequence number.

9. A method of initiating a financial transaction between a payor and a payee, the method comprising:
receiving, in a payor mobile electronic device, data pertaining to identification of the payee and a transaction amount;
selecting, by the payor mobile electronic device, a pre-issued virtual check number associated with a payor financial account for use in the financial transaction;
generating an image of a two dimensional barcode that encodes the received data and the pre-issued virtual check number; and
transmitting the image toward a payee mobile electronic device for display of the image by the payee mobile electronic device to an image sensor of a payee financial services organization, wherein displaying of the image causes the payee financial services organization to initiate a transfer, of the transaction amount, from the payor financial account, to an account of the payee, according to the pre-issued virtual check number.

10. A method according to claim 9, wherein one or both of the payee mobile electronic device and the payor mobile electronic device is a smartphone.

11. A method according to claim 9, wherein the two dimensional barcode is a QR code.

12. A method according to claim 9, wherein the image is transmitted to the payee mobile electronic device from the payor mobile electronic device.

13. A method according to claim 12, wherein the image is transmitted using MMS, email, chat, screen sharing, or NFC.

14. A method according to claim 9, wherein the image is transmitted to the payee mobile electronic device from an electronic system of the payor financial services organization.

15. A method according to claim 9, wherein the image sensor comprises an ATM or a bank teller device.

16. A method according to claim 9, wherein the barcode image further encode a unique transaction sequence number.

17. A computer-readable medium in which is stored non-transitory computer program code for initiating a financial transaction between a payor and a payee, the computer program code comprising:
program code for receiving, in a payor mobile electronic device, data pertaining to identification of the payee and a transaction amount;
program code for selecting, by the payor mobile electronic device, a pre-issued virtual check number associated with a payor financial account for use in the financial transaction;
program code for generating an image of a two dimensional barcode that encodes the received data and the pre-issued virtual check number; and
program code for transmitting the image toward a payee mobile electronic device for display of the image by the payee mobile electronic device to an image sensor of a payee financial services organization, wherein displaying of the image causes the payee financial services organization to initiate a transfer, of the transaction amount, from the payor financial account, to an account of the payee, according to the pre-issued virtual check number.

18. A medium according to claim 17, wherein one or both of the payee mobile electronic device and the payor mobile electronic device is a smartphone.

19. A medium according to claim 17, wherein the two dimensional barcode is a QR code.

20. A medium according to claim 17, wherein the image is transmitted to the payee mobile electronic device from the payor mobile electronic device.

21. A medium according to claim 20, wherein the image is transmitted using MMS, email, chat, screen sharing, or NFC.

22. A medium according to claim 17, wherein the image is transmitted to the payee mobile electronic device from an electronic system of the payor financial services organization.

23. A medium according to claim 17, wherein the image sensor comprises an ATM or a bank teller device.

24. A medium according to claim 17, wherein the transaction sequence number is a number of a bank check associated with the payor financial account.
